(19) United States
(12) Patent Application Publication
(10) Pub. No.: US 2010/0272930 A1
(43) Pub. Date: Oct. 28, 2010

(54) GPS Heat Shield

(76) Inventor: Eric Muise, St. Petersburg, FL (US)

Correspondence Address: Eric Muise, apt. # E, 10472 2nd way N., Saint Petersburg, FL, 33716, US

(21) Appl. No.: 12/428,516

(22) Filed: Apr. 23, 2009

(51) Int. Cl. B32B 1/02

(52) U.S. Cl. 428/34.1

(57) ABSTRACT

A protective device which houses and shields global positioning systems used for automobile navigation, commonly called and referred from here on out as a Gps device. Gps devices become subject to intense heat which can develop as a result of solar emissions being focused through an automobiles' windshield or the automobiles' general embodiment. As the heat from solar emissions intensifies, Gps devices that have been fixed or mounted to the interior windshields of an automobile, are particularly susceptible to malfunction or even permanent damage. Creating a Gps heat shield accessory will advert the painful loss people incur when their Gps is damaged by this excessive heat produced when solar emission are magnified through an automobiles windshield or by the automobiles general embodiment.

### BACKGROUND OF THE INVENTION

1. Field of the Invention

The Present invention relates to Gps devices used inside of Automobiles.

2. Description of the Prior Art

While Gps devices are still relatively very new to society, I have found none that have instituted a means to shield a Gps device from the harmful solar heat that can damaged such a device when mounted to the interior windshield of an automobile.

### SUMMARY OF THE INVENTION

It is therefore the object of the present invention to provide a safe means to protect a Gps device from the heat produced from solar emissions within an automobiles embodiment.

It is therefore the object of the present invention to provide a means by which owners of Gps devices, do not incur damage or loss of function to their Gps device as related to heat specific issues.

It is therefore the object of the present invention to provide the peace of mind, and confidence this present invention offers, to ensure owners will not suffer any damage to their Gps devices which can be a relatively expensive investment.

### BRIEF DESCRIPTION OF THE DRAWINGS

FIG. 1 is a perspective front view of the Gps heat shield of the present invention.

FIG. 2 is a perspective side view of the Gps heat shield of the present invention.

FIG. 3 is a perspective front view of a Gps device.

FIG. 4 is a perspective side view of a Gps device.

FIG. 5 is a perspective working cross-sectional view and the Gps heat shield of FIG. 2 and, of the Gps embodiment of FIG. 4 functioning together.

FIG. 6 is a perspective working front view of the Gps heat shield of FIG. 1 and the Gps embodiment of FIG. 3 together.

### DETAILED DESCRIPTION OF THE DRAWINGS

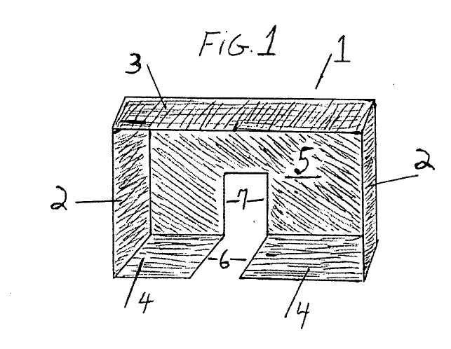

FIG. 1 is a front view of the Gps heat shield 1, having a pair of sidewalls 2, an upper ceiling wall 3, a bottom wall 4, and a recessed rear wall 5. The bottom wall 4, has a relevantly substantial notch 6. The rear wall 5, has a relevantly substantial notch 7.

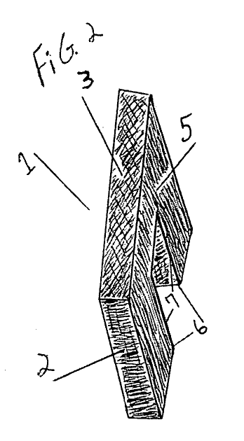

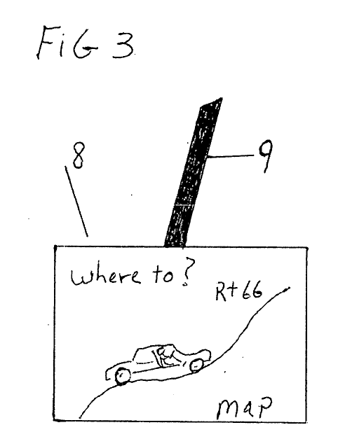

FIG. 2 is a side view of the Gps heat shield 1 providing further understanding of its simple and basic yet effective means to protect a very expensive investment known as a Gps device 8, of FIG. 3.

FIG. 3 is a front view of the Gps device 8, shown having a native windshield mounting fixture 9.

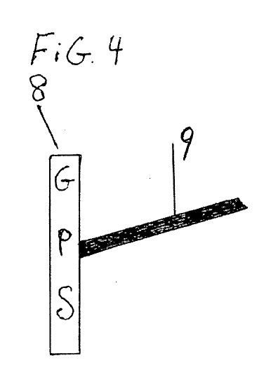

FIG. 4 is a side view of the Gps device 8 of FIG. 3. Providing reference to help clarify how both the object of FIG. 1 joins with the Object of FIG. 3.

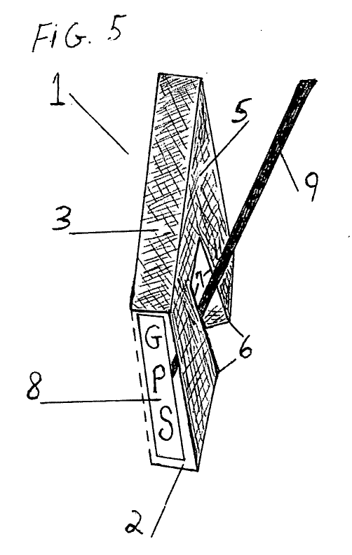

FIG. 5 is a perspective side view of the Gps heat shield 1, of FIG. 2; housing the Gps device 8, of FIG. 4. The Gps heat shield 1, mounts by resting the rear wall 5 on FIG. 3 #9. The Gps beat shield 1, fits over the Gps device 8, via the notch 6 incorporated into the bottom wall 4 and the notch 7 incorporated into the rear wall 5.

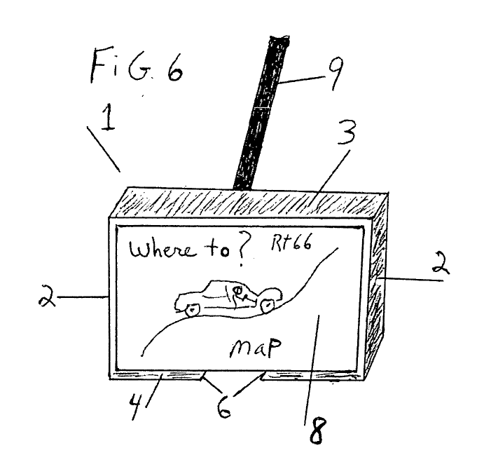

FIG. 6 is a perspective front view of the Gps heat shield 1, of FIG. 1; housing and shielding the Gps device 8 of FIG. 3. from any excessive heat (not shown).

What I claim is:

1. A global positioning system heat shield:
a) said global positioning system heat shield having an inner portion, an outer portion, and walls, said inner portion defining an inner space, said walls having a side portion, a bottom portion, a rear portion, and a upper portion defining an outer surface defined by a peripheral edge.

2. said global positioning system beat shield of claim 1, wherein said walls may vary in size.

3. said global positioning system heat shield of claim 1, wherein said walls may be adjustable so as to increase or decrease the said inner portion of said inner space of said peripheral edge of said global positioning system heat shield.

4. said global positioning system heat shield of claim 1, wherein said global positioning system heat shield; substantially deflects and resists heat.

5. said global positioning system heat shield of claim 1, wherein said global positioning system heat shield is made of substantially heat deflective and heat resistant materials such as acrylics, Polycarbonates, foams, metals, plastics and enamels.

6. said global positioning system heat shield of claim 1, wherein said global positioning system heat shield houses and protects the commonly known global positioning systems used in automobiles for navigation; from excessive heat produced from the solar radiation and other common heat producing factors inherently related to automobiles.

7. said global positioning system heat shield of claim 1, wherein said global positioning system heat shield may removably attached by an conventional method or material known to the art to any common surface known to man; such as would relate to a global positioning systems for automobiles, or global positioning system windshield or dashboard fixture attachments for automobiles.
